(19) United States
(12) Patent Application Publication
(10) Pub. No.: US 2024/0183765 A1
(43) Pub. Date: Jun. 6, 2024

(54) MICROFLUIDIC DEVICE AND METHOD FOR EXTRACTING BLOOD PLASMA FROM WHOLE BLOOD

(71) Applicant: City University of Hong Kong, Kowloon (HK)

(72) Inventors: Ting-Hsuan Chen, Kowloon Tong (HK); Hogi Hartanto, Kowloon Tong (HK)

(21) Appl. No.: 18/490,160

(22) Filed: Oct. 19, 2023

Related U.S. Application Data
(60) Provisional application No. 63/509,110, filed on Jun. 20, 2023.
(60) Provisional application No. 63/385,796, filed on Dec. 2, 2022.

(51) Int. Cl. G01N 1/40; G01N 1/34

(52) U.S. Cl. CPC G01N 1/4005; G01N 1/34; G01N 2001/4016

(57) ABSTRACT

A microfluidic device contains a blood sample inlet, a separation membrane, a manifold inlet in fluid connection with the blood sample inlet at a junction, a capillary pump in fluid connection with and downstream of the junction, and an air vent in in fluid connection to the capillary pump. The separation membrane contains a top layer proximal to the sample inlet, and a bottom layer distal to the sample inlet. The top layer has an average pore size of from about 1 μm to about 50 μm in diameter. The bottom layer has an average pore size of from about 0.05 μm to about 20 μm in diameter. The separation membrane is positioned between the blood sample inlet and the junction.

### FIELD OF THE INVENTION

The present invention relates to a microfluidic device and method. More specifically, the present invention relates to a microfluidic device and method for extracting blood plasma from a blood sample.

### BACKGROUND

Point of Care (POC) diagnosis and treatment is becoming increasingly important to screen for various conditions and/or to efficiently provide health care. Blood plasma separated from a blood sample is known to be a readily-available reservoir of biomarkers and typically requires physical separation from other blood components such as red blood cells (RBCs), white blood cells (WBCs) including phagocytes, etc. prior to analysis. Such separation typically occurs via, for example, centrifugation, and requires trained laboratory personnel and special equipment. Furthermore, laboratory centrifuges require a constant electricity supply in order to spin the rotor to effectively separate blood plasma from other blood components.

Blood plasma separation and extraction (BPSE) devices and methods are known (see, Mielczarek, et al., “Microfluidic blood plasma separation for medical diagnostics: Is it worth it?”, Lab Chip, vol. 16, pp. 3441, 2016, and Gao, et al., “A simple and rapid method for blood plasma separation driven by capillary force with an amplification in protein detection”, anal. Met., vol. 12, pp. 2560-70, 2020); however such methods typically require, for example, long extraction times, low blood plasma extraction volumes, blood sample pretreatment, etc.

While blood filtration is well-known, manually- or electrically-powered devices possess significant drawbacks such as consistency of use and the need for power sources, respectively. Thus, manual pump-powered devices require a trained professional to operate, while powered devices may need a power outlet, batteries, etc. Sequential reservoir draining is also known (see Olanrewaju and Juncker, “Autonomous microfluidic capillaric circuits replicated from 3D-printed molds”, Lab Chip, vol. 16, p. 19, 2016) to provide self-regulating liquid drainage system.

Additional Microfluidic devices are described by, for example, Wang, et al., Portable microfluidiv device with thermometer-like display for real-time visual quantitation of Cadmium (II) contamination in drinking water, Analytica Chimica Acta, vol. 1160, 338444, 2021, https://doi.org/10.1016/j.aca.2021.338444: Wu, et al., Cascade-Amplified Microfluidic Particle Accumulation Enabling Quantification of Lead Ions through Visual Inspection, Sens & Actuators: B. Chemical, vol. 324, 128727, https://doi.org/10.1016/j.snb.2020.128727; Jiang, et al., Microfluidic particle accumulation for visual quantification of copper ions, Microchimica Acta, vol. 188, 176, 2021, https://doi.org/10.1007/s00604-021-04822-0; Wu, et al., Visual quantification of silver contamination in fresh water via accumulative length of microparticles in capillary-driven microfluidic devices, Talanta, vol. 235, 122707, 2021, https://doi.org/10.1016/j.talanta.2021.122707; Zhao, et al., Micrfluidic bead trap as a visual bar for quantitative detection of oligonucleotides, Lab Chip, 2017, DOI: 10.1039/c7lc00836h and Wang, et al., Microfluidic Particle Dam for Visual and Quantitative Detection of Lead Ions, ACS. Sens., vol. 5, pp. 19-23, 2020, DOI: 10.1021/acssensors.9b01945.

Accordingly, the need remains for portable, simple, POC devices and methods, especially unpowered POC devices, for faster, more efficient, separation and/or biomarker screening, especially without the need for blood sample dilution. The need further exists for easy-to-use devices which do not require specifically trained lab personnel to use them, and for devices which may achieve significant separation without the need for an active pump, such as one using electric power. The need also remains for an all-in-one device which may automatically diagnose a disease from a blood sample. The need also remains for a device and process which allows gentle separation of blood plasma from whole blood samples, while reducing or avoiding cell lysis/hemolysis.

### SUMMARY OF THE INVENTION

In an embodiment of the invention herein, a microfluidic device contains a blood sample inlet, a separation membrane, a manifold inlet in fluid connection with the blood sample inlet at a junction, a capillary pump in fluid connection with and downstream of the junction, and an air vent in in fluid connection to the capillary pump. The separation membrane contains a top layer proximal to the sample inlet, and a bottom layer distal to the sample inlet. The top layer has an average pore size of from about 1 μm to about 50 μm in diameter; or from about 3 um to about 20 μm in diameter; or from about 7 μm to about 13 μm in diameter. The bottom layer has an average pore size of from about 0.05 μm to about 20 μm in diameter; or from about 0.1 μm to about 7 μm in diameter; or from about 1 μm to about 3 μm in diameter. The separation membrane is positioned between the blood sample inlet and the junction.

Without intending to be limited by theory, it is believed that the typical biomarkers are smaller than, for example, red blood cells and white blood cells (e.g., including phagocytes). Therefore, it is believed that the invention herein may separate, for example, red blood cells, white blood cells, etc. from, for example, a whole blood sample, while allowing blood plasma and desired biomarkers to pass through the separation membrane and to flow downstream to the junction and the capillary pump. The invention provides a new blood separation device and method that utilizes a pressure difference to separate blood plasma from whole blood across a membrane/porous material. Pressure differences can be utilized using various equipment such as a syringe pump, hydrostatic pump, peristaltic pump, etc. These devices' core structure may also come in different forms such as a syringe and their add-ons, as well as elastic pipes which are equipped with a type of membrane/porous material that aids the separation or purification of blood plasma from whole blood samples. Alternatively, a capillary pump may be employed herein to draw the blood downstream from the blood sample inlet.

In an embodiment of the invention herein, a method for separating blood plasma from a blood sample includes the steps of providing the microfluidic device according to any one of the previous claims, providing a blood sample containing a plurality of red blood cells and blood plasma, opening the air vent either before or after adding the blood sample to the blood sample inlet if the air vent is initially closed, adding the blood sample to the blood sample inlet allowing the blood sample to flow from the blood sample inlet downstream to the separation membrane, filtering the red blood cells from the blood plasma, adding a working fluid to the manifold inlet, and finally extracting the blood plasma separated by the separation membrane. The blood plasma will be extracted through sequential draining of the working fluid through the separation membrane. The air vent may be closed with an air vent cover, for example, a removable seal, a sticker, a plastic plug, etc.

Without intending to be limited by theory, it is believed that, the method herein provides a simple, easy, and fool-proof method for separating blood plasma, and any biomarkers therein, from RBCs, WBCs, dirt, etc. which would either clog up and/or complicate further analysis. It is believed that the present method may be designed for a simple test kit, or may be, for example, scaled up for larger-scale blood sample purification and/or biomarker separate and/or identification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A shows an electrical circuit diagram to simulate flow resistance of an embodiment of the device of the present invention;

FIG. 1B shows a top-perspective view of an embodiment of the microfluidic device of the present invention;

FIG. 1C shows a side view of the embodiment of FIG. 1B;

FIG. 2 shows a schematic, partially-exploded diagram of an embodiment of the microfluidic device of the present invention;

FIG. 3A shows a photo of red blood cells stained with DiD;

FIG. 3B shows a photo of white blood cells stained with CMFDA green.

FIG. 4 shows photos of the microfluidic device, phase contrast image, Cy5, TXRED, and FITC fluorescence image during the blood plasma extraction process at certain points in time;

FIG. 5A is a graph showing the relative fluorescent intensity of Cy5 dye spiked in whole blood in an embodiment of the invention;

FIG. 5B is a graph showing the relative fluorescent intensity of Cy5 dye spiked in blood plasma in an embodiment of the invention;

FIG. 6 shows the average relative fluorescence intensity of TXRED and FITC channels indicating the extraction of blood plasma without leakage and rupture of red blood cells (RBCs) and white blood cells (WBCs) inside the reaction chamber in different concentrations of spiked blood plasma; and

FIG. 7 is a graph comparing extracted plasma volumes between blood plasma and whole blood samples in different expected plasma volumes.

The figures herein are for illustrative purposes only and are not necessarily drawn to scale.

### DESCRIPTION OF THE PREFERRED EMBODIMENTS

Unless otherwise specifically provided, all tests herein are conducted at standard conditions which include a room and testing temperature of 25° C., sea level (1 atm.) pressure, pH 7, are unpowered, and all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide.

As used herein, the term “downstream” is a relative term which indicates in a direction towards the air outlet.

As used herein, the term “upstream” is a relative term which indicates in a direction away from the air outlet, typically towards the blood sample inlet and/or the manifold inlet.

In an embodiment of the invention herein, a microfluidic device contains a blood sample inlet, a separation membrane, a manifold inlet in fluid connection with the blood sample inlet at a junction, a capillary pump in fluid connection with and downstream of the junction, and an air vent in in fluid connection to the capillary pump. The separation membrane contains a top layer proximal to the sample inlet, and a bottom layer distal to the sample inlet. The top layer has an average pore size of from about 1 μm to about 50 μm in diameter; or from about 3 um to about 20 μm in diameter; or from about 7 μm to about 13 μm in diameter. The bottom layer has an average pore size of from about 0.05 μm to about 20 μm in diameter; or from about 0.1 μm to about 7 μm in diameter; or from about 1 μm to about 3 μm in diameter. The separation membrane is positioned between the blood sample inlet and the junction.

Without intending to be limited by theory, it is believed that the typical biomarkers are smaller than, for example, red blood cells and white blood cells (e.g., including phagocytes). Therefore, it is believed that the invention herein may separate, for example, red blood cells, white blood cells, etc. from, for example, a whole blood sample, while allowing blood plasma and desired biomarkers to pass through the separation membrane and to flow downstream to the junction and the capillary pump.

The capillary pump herein draws fluid through the device by, for example, wicking, capillary action, etc. The capillary pump herein may be selected from the group of a porous-material-based capillary pump, a single microchannel with a hydrophilic surface, a multiple microchannel with hydrophilic surface, a chamber with hydrophilic microstructure and a combination thereof. In an embodiment herein, the porous-material-based capillary pump includes a filter, e.g., a filter paper. Useful filter paper material(s) include, e.g., cellulose, cotton linter derived material(s), etc. In some embodiments, the source or the porous-material-based capillary pump is made of porous material(s) which draw the fluid flow downstream via capillary action. Thus, it is believed that in an embodiment herein no electrical power or active pump is required. Without intending to be limited by theory, it is believed that such a feature may help to reduce or avoid potential clogging of the porous-material-based capillary pump during use.

In an embodiment herein, the capillary pump herein may contain a microstructure which helps to draw fluid through the device. The microstructure may include, for example, a microchannel; or a plurality of microchannels, with or without a plurality of microstructures.

In an embodiment herein, the capillary pump is unpowered, meaning it is self-driven and does not consume any electricity or require an external power source in order to draw fluid through the device.

In an embodiment herein, the separation membrane's top layer has an average pore size of from about 7 μm to about 13 μm in diameter and the bottom layer has an average pore size of from about 1 μm to about 3 μm in diameter. Without intending to be limited by theory, it is believed that these pore sizes are optimized for effectively filtering out RBCs, WBCs, etc. from blood plasma in typical human blood samples.

In an embodiment herein, the separation membrane further includes an additional layer located proximal to the sample inlet and above the top layer. In such a case, the average pore size of the additional layer may be, for example, from about 20 μm to about 100 μm in diameter; or from about 30 μm to about 75 μm in diameter; or from about 40 μm to about 50 μm in diameter. Without intending to be limited by theory, it is believed that such an additional filter may remove larger contaminants in the blood sample, such as, for example, dirt, aggregated platelets, skin cells, tissues, microbes/bacteria, etc., which could otherwise reduce the effectiveness of, and/or clog up the top filter.

In an embodiment herein, the microfluidic device further contains a reaction chamber in fluid connection with the separation membrane, where the reaction chamber is downstream of the separation membrane. The reaction chamber's function may be to provide a location for a chemical reaction, or a physical reaction, such as the detection of a biomarker with, for example, a reactant for a reaction selected from the group of a color reaction, an antibody reaction, an enzymatic reaction, an electrochemical reaction, fluorescence, chemiluminescence, and a combination thereof; or a color reaction, an antibody reaction, an enzymatic reaction, and a combination thereof. The reaction chamber may, for example, detect a biomarker from the blood plasma. Such a biomarker may be, for example, alpha fetoprotein, a SARS COV-2 antibody, a SARS COV-2 antigen, serum albumin, prostate-specific antigen, blood creatinine, blood cystatin C, and a combination thereof.

The microfluidic device, and specifically the reaction chamber, may further contain a capture mechanism such as, for example, an immobilized antibody, an immobilized antigen, an immobilized microparticles, and a combination thereof, to assist in the capture of the biomarker. The capture mechanism may be, for example, a reversible capture mechanism which can, for example, release the capture biomarker upon providing a release solution and adding the release solution to the reaction chamber. The release solution may achieve such biomarker release by, for example, utilizing a different ionic strength, pH, etc. than that of the original blood sample.

The reaction chamber may be, for example, between the separation membrane and the capillary pump, or may even be contained within the capillary pump. In an embodiment herein, the reaction chamber is included within the capillary pump. In an alternate embodiment, the reaction chamber protrudes from the microfluidic device downstream of the separation membrane, for example, after or parallel to the capillary pump, or is located directly downstream of the separation membrane.

Thus, an embodiment of the invention relates to a blood separation device and method that utilizes a pressure difference between the blood sample inlet, the manifold inlet, and the capillary pump to separate blood plasma from whole blood across a separation membrane. One skilled in the art understands that pressure differences can be utilized using various equipment such as a syringe pump, hydrostatic pump, peristaltic pump, etc., and especially a capillary pump. One skilled in the art further understands that the core structure may also come in different forms such as a syringe and their add-ons, as well as elastic pipes equipped with a separation membrane that aids the separation or purification of blood plasma from whole blood samples.

An embodiment of the invention relates to a microfluidic device with capillary driven pressure differences across a separation membrane. The microfluidic device may contain a microchannel or a plurality of microchannels for fluids which travel downstream along the pathway through a fluid wicking mechanism based on the capillary pump's wettability. Typical fluid wicking materials include hydrophilic materials such as hydrophilic polymers (PDMS, acrylic) and ceramics (glass). The pressure difference for capillary driven devices may come from the fluids interface when in contact with the geometry of the microchannel/pathway. Such materials such as porous membranes (filter paper, cotton, fibrous membranes, stacked microparticles) that allow for a micro sized interfaces may create a pressure gradient that allows for fluid to flow across a channel/pathway and when combined with separation porous membranes. Thus, it can separate blood plasma from whole blood whose large particles such as RBCs, WBCs, etc. are caught on the separation membrane.

In an embodiment of the invention herein, the microfluidic device herein provides blood plasma separation using capillary induced pressure difference across a separation membrane which by utilizing sequential draining to ensure automated, unpowered, and virtually complete separation and extraction of blood plasma from a whole blood sample. The device components such as the blood sample inlet/channel, manifold inlet/channel, and reaction chamber have specifically designed dimensions that come with their own pressures and resistances when these channels are filled with fluids. The pressure difference between blood sample inlet/channel, manifold inlet/channel, and reaction chamber are designed such that the liquid meniscus from the blood sample inlet will be drained first, while the liquid at the manifold inlet will stay still. The liquid meniscus from the manifold inlet will only move when the liquid in the blood sample inlet is completely drained. This principle ensures complete extraction of blood plasma. In addition, during the extraction, the device and method reduces the pressure drop across the porous membrane to accommodate the increasing flow resistance when blood cells are captured. Thus, hemolysis, a common problem in other methods, can be greatly minimized.

### Sequential Draining Parameter Calculation

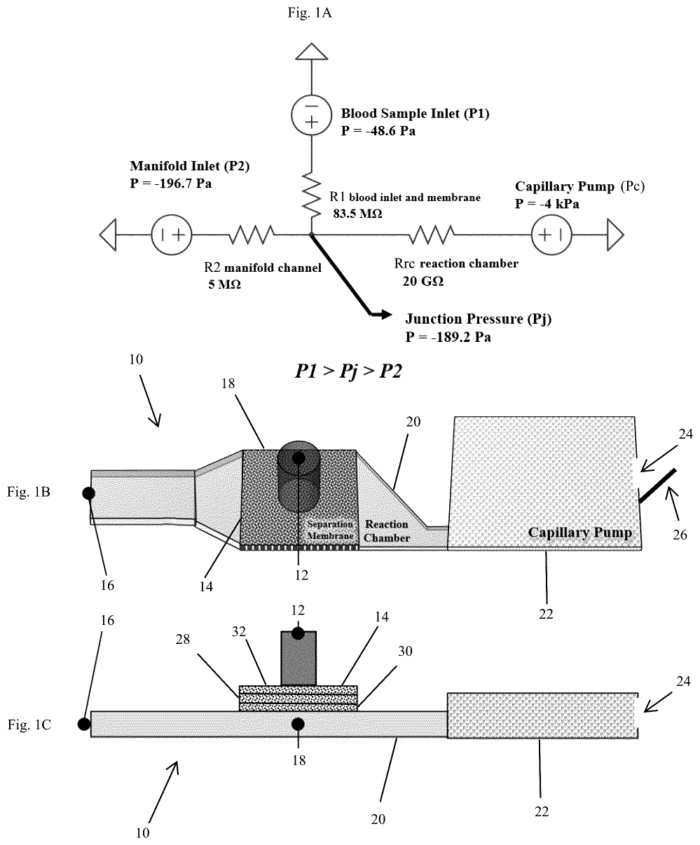

Sequential draining is a self-regulating liquid drainage given a system with multiple incoming reservoirs which allows the manipulation of liquid inside of the microchannel. Using sequential draining, we can ensure the complete drainage of a liquid from one reservoir before the drainage of fluid from other reservoirs. To satisfy the conditions of sequential draining, the meniscus pressure on the inlet with draining priority (P₁), the liquid pressure at the junction between inlet 1 and 2 (Pⱼ), and the pressure of the inlet with the lower draining priority (P₂) should follow the condition: P₁>Pⱼ>P₂ (see FIG. 1A, FIG. 1B and FIG. 1C). The liquid meniscus pressures on the inlet and flow resistances can be determined using the following equations:

$$\\ \begin{matrix}P = - γ [ \frac{( cos {θ}_{l} + cos {θ}_{r} )}{w} + \frac{( cos {θ}_{t} + cos {θ}_{b} )}{h} ] & ( Equation 1 )\end{matrix}$$

$$\\ \begin{matrix}R = {\frac{12 η L}{{h}^{{}_{} 3} w} [ 1 - 0.63 \frac{h}{w} ]}^{{}_{} - 1} & ( Equation 2 )\end{matrix}$$

where cosθ_{l,r,t,b} is the contact angle of the materials that composed of the left, right, top, and bottom boundaries respectively, γ is the surface tension of the fluid, η is the dynamic viscosity of the fluid, while w, h, L are the width, height, and length of the channel. See Olanrewaju and Juncker, above.

To find the pressure balances, an electrical model is used to simulate the capillary microfluidics (see FIG. 1A). Through an online simulation service (e.g., CircuitLab https://www.circuitlab.com/) and equations (1) and (2), the pressures and resistances of the channel could be readjusted by reverse engineering the channel dimensions to fulfil the prerequisite condition of sequential draining.

### Device Fabrication

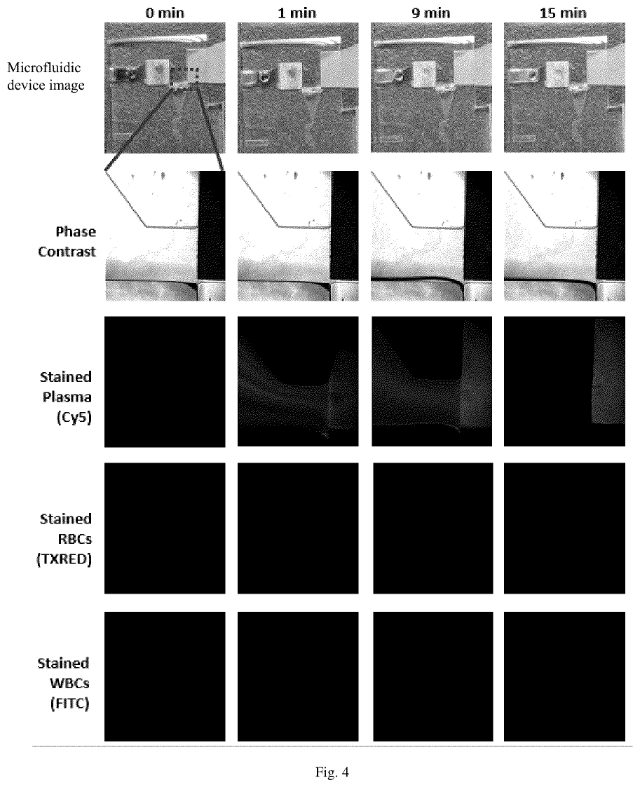

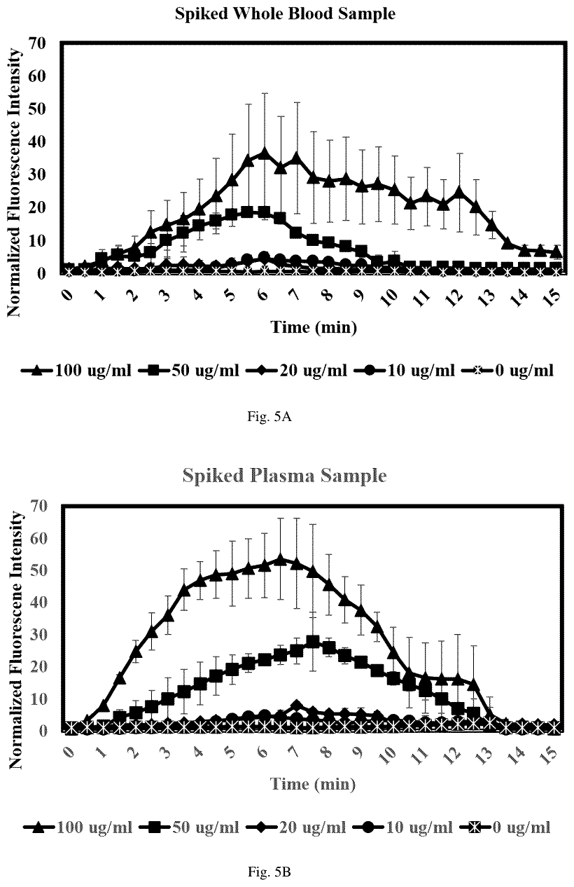

In an embodiment herein, the device may contain a channel layer made of block copolymer PDMS (polydimethyl siloxane) and a sealing layer made of glass, such as a glass slide. Without intending to be limited by theory, it is believed that a glass slide is especially useful as it allows a user to directly observe the microfluidic device in action (see, e.g., FIG. 4). The channel layer mold is first designed with AutoCAD referencing the dimensions measured from the sequential draining calculations. A 3D-printer (Phrozen Sonic Mini 8K, Hsinchu City 30091, Taiwan R.O.C.) with standard UV sensitive resin (ANYCUBIC, Shenzhen, Guangdong, China) is used to create the mold. After ultrasonication with isopropyl alcohol for 5 minutes to clean any liquid resin residue, the printed mold is then cured in a UV chamber for 3 minutes. The mold is then treated with hexamethyldisilane (HMDS; Sigma-Aldrich, New Jersey, USA) for 5 minutes through chemical vapor deposition (CVD) to prevent the adhesion of the polydimethylsiloxane (PDMS; Sylgard, Michigan, USA) to the 3D printed mold.

Dimethyl siloxane-(60-70% Ethylene Oxide) block copolymer 20 cSt (Gelest, Pennsylvania, USA) is mixed with PDMS prepolymer (10:1) with a w/w ratio of 0.75% to form a mixture. The mixture is poured onto the 3D-printed mold and baked for 4 hours at 75° C. to cure and form a solidified block copolymer PDMS device. The solidified block copolymer PDMS device is peeled from the mold, trimmed, and fitted with the separation membrane in the designated slot. The block copolymer PDMS device and a glass slide are then plasma treated (Harrick Plasma PDC-001, New York, USA) for 3 minutes at 700 mTorr and then bonded via slight compression to create an enclosed device. The enclosed device is then heated for 5 minutes at 95° C. to ensure tighter bonding and to remove the plasma hydrophilic effect on the block copolymer PDMS and glass slide. Filter paper is then inserted into the outlet slot to act as the capillary pump for the device (See FIG. 1).

### Method of Separating Blood Plasma from a Blood Sample

In an embodiment of the invention herein, a method for separating blood plasma from a blood sample includes the steps of providing the microfluidic device according to any one of the previous claims, providing a blood sample containing a plurality of red blood cells and blood plasma, opening the air vent either before adding the blood sample blood sample inlet or after adding the blood sample to the blood sample inlet if the air vent is initially closed, adding the blood sample to the blood sample inlet, allowing the blood sample to flow from the blood sample inlet to the separation membrane, filtering the red blood cells from the blood plasma, adding a working fluid to the manifold inlet, and finally the blood plasma separated by the separation membrane will be extracted through sequential draining. Initially, the microfluidic device may come with the air vent in a closed state; i.e., is a closed air vent. The air vent may be closed with an air vent cover, for example, a removable seal, a sticker, a plastic plug, etc. The air vent is opened in order to allow the blood sample to flow through the device.

Without intending to be limited by theory, it is believed that, the method herein provides a simple, easy, and fool-proof method for separating blood plasma, and any biomarkers therein, from RBCs, WBCs, dirt, etc. which would either clog up and/or complicate further analysis. It is believed that the present method may be designed for a simple test kit, or may be, for example, scaled up for larger-scale blood sample purification and/or biomarker separate and/or identification.

In an embodiment herein, the blood plasma flows from the separation membrane downstream to the capillary pump, where it may be collected, etc.

In embodiments where the microfluidic device further includes a reaction chamber, the method herein may further include the step of reacting the biomarker(s) with a reactant in the reaction chamber.

Turning to the figures, FIG. 1A shows an electrical circuit diagram to simulate flow resistance of an embodiment of the device of the present invention. In FIG. 1A, blood sample inlet has a pressure, P1, of −48.6 Pa, while a manifold inlet has a pressure, P2, of −196.7 Pa. The resistance, R1, from the blood sample inlet and the membrane is 83.5 MΩ while the resistance, R2, from the manifold inlet is 5 MΩ. This provides a junction pressure, Pj, of −189.2 Pa at the junction, and satisfies the condition P1>Pj>P2. The reaction chamber provides a resistance, Rrc, of 20 GΩ, while the capillary pump provides a pressure, Pc, of −4 kPa.

FIG. 1B shows a top-perspective view of the embodiment of the microfluidic device, 10, of the present invention. The microfluidic device, 10, contains a blood sample inlet, 12, connected to a separation membrane, 14. A separate manifold inlet, 16, is distal to and in fluid connection with the blood sample inlet, 12, at a junction, 18, via the separation membrane, 14. A reaction chamber, 20, is downstream of the junction, 18, while a capillary pump, 22, is in fluid connection with and downstream of the reaction chamber, 20, and the junction, 18. An air vent, 24, is in downstream fluid communication with the capillary pump, 22, and an air vent cover, 26, which in this case is a sticker, is shown being peeled away from the air vent, 24. The air vent can be always opened or kept closed until use. For the latter case, the air vent cover, 26, will typically cover and seal the air vent, 24, and the air vent cover, 26, may be removed after the blood sample is added to the blood sample inlet, 12. Once the blood sample is added to the blood sample inlet, 12, and has passed through the separation membrane, 14, then the working fluid may be added to the manifold inlet, 16, so as to extract the blood plasma from the separation membrane, 14.

In FIG. 1B, one skilled in the art understands that the separation membrane, 14, is downstream of the blood sample inlet, 12, and the junction, 18, is downstream of the separation membrane, 14. Similarly, the junction, 18, is downstream of the manifold inlet, 16. Conversely, the manifold inlet, 16, is upstream of the junction, 18.

FIG. 1C shows a side view of the embodiment of FIG. 1B. The microfluidic device, 10, has a blood sample inlet, 12, a separation membrane, 14, a manifold inlet, 16, a junction, 18, a reaction chamber, 20, a capillary pump, 22, and an air vent, 24. In this view, it can be seen that the separation membrane, 14, contains a top layer, 28, proximal to the blood sample inlet, 12. The separation membrane, 14, also contains a bottom layer, 30, distal to the blood sample inlet, 12. The top layer, 28, is in fluid connection to the bottom layer, 30, and in this embodiment the top layer, 28, is directly upstream of the bottom layer, 30. Upstream of the top layer, 28, is an optional, additional layer, 32, which may further help to remove unwanted materials, such as larger particles, from the blood sample before it flows to the top layer, 28.

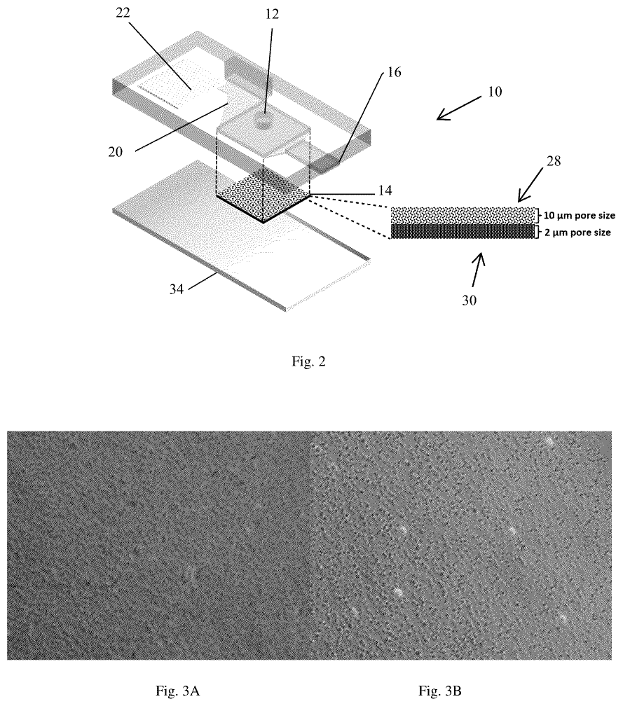

FIG. 2 shows a schematic, partially-exploded diagram of an embodiment of the microfluidic device, 10, of the present invention. The microfluidic device, 10, is oriented in the opposite direction from that of FIG. 1B, and contains a blood sample inlet, 12, a separation membrane, 14, a manifold inlet, 16, a reaction chamber, 20, and a capillary pump, 22. The separation membrane, 14, is exploded from the microfluidic device, 10, and the close-up shoes the top layer, 28, having different pore size of 10 μm and the bottom layer, 30, having a pore size of 2 μm. FIG. 2 also shows a glass slide, 34, which may be affixed to the microfluidic device, 10.

FIG. 3A shows a photo of red blood cells stained with DiD, where the red coloring indicates the presence of red blood cells.

FIG. 3B shows a photo of white blood cells stained with CMFDA green, where the green coloring indicates the presence of white blood cells.

FIG. 4 shows photos of the microfluidic device, phase contrast image, Cy5, TXRED, and FITC fluorescence image during the blood plasma extraction process at certain points in time. The top row of photos shows an embodiment of the microfluidic device herein under normal light conditions. The second row (from the top) shows the phase contrast of a close-up of the reaction chamber and the edge of the capillary pump. The third row shows a close-up of Cy5 stained-plasma passing through the reaction chamber and the edge of the capillary pump. The fourth row shows a close-up of DiD-stained red blood cells passing through the reaction chamber and the edge of the capillary pump. The fifth row shows a close-up of CMFDA-stained white blood cells passing through the reaction chamber and the edge of the capillary pump.

To prepare the microfluidic device, the blood sample with either Cy5-stained blood plasma (row 3), DiD-stained RBCs (4^{th} row), or CMFDA-stained WBCs (5^{th} row) is added into the blood sample inlet and the working fluid is added to the manifold inlet.

The first (left) column of all rows indicates the zero-timepoint; i.e., 0 min after releasing the working fluid contact the capillary pump. The second column of all rows indicates the 1 minute timepoint after the working fluid contact the capillary pump. The third column of all rows indicates the 9 minute timepoint after the working fluid contact the capillary pump. The fourth (right) column of all rows indicates the 15 minute timepoint after the working fluid contact the capillary pump.

As can be seen in FIG. 4, no plasma, RBCs, or WBCs are visible in the reaction chamber or the capillary pump at the zero-timepoint. At the 1 minute timepoint, it can be seen that Cy5-stained blood plasma is passing though the reaction chamber and beginning to accumulate in the capillary chamber, while no RBCs or WBCs are passing through the reaction chamber or accumulating in the capillary chamber. At the 9 minute timepoint, FIG. 4 shows increased Cy5-stained blood plasma is passing though the reaction chamber and accumulating in the capillary chamber, while no RBCs or WBCs are passing through the reaction chamber or accumulating in the capillary chamber. At the 15 minute timepoint, FIG. 4 shows the Cy5-stained blood plasma has completely passed through the reaction chamber and is all accumulated in the capillary chamber, while no RBCs or WBCs have passed through the reaction chamber or accumulated in the capillary chamber. The FIG. 4 photos therefore show that blood plasma flows quickly and completely through the blood sample inlet, the separation membrane, the junction, and the reaction chamber within 15 minutes and accumulates in the capillary pump. However, it is equally clear that RBCs and WBCs do not pass through the separation membrane and therefore never enter the junction, the reaction chamber, or the capillary pump. Furthermore, it is seen from FIG. 4 that the RBCs and WBCs caught in the separation membrane do not hinder the flow of the blood plasma downstream, as it is all caught in the capillary pump.

FIG. 5A is a graph showing the relative fluorescent intensity of Cy5 dye spiked in whole blood in an embodiment of the invention. This shows that the peak fluorescence intensity of Cy5-stained whole blood is about 6 minutes, and that the staining is easily-detectable even after 15 minutes.

FIG. 5B is a graph showing the relative fluorescent intensity of Cy5 dye spiked in blood plasma in an embodiment of the invention. This shows that the peak fluorescence intensity of Cy5-stained blood plasma is about 6.5 minutes, and that the normalized fluorescence intensity of blood plasma is higher than that of whole blood (FIG. 5A).

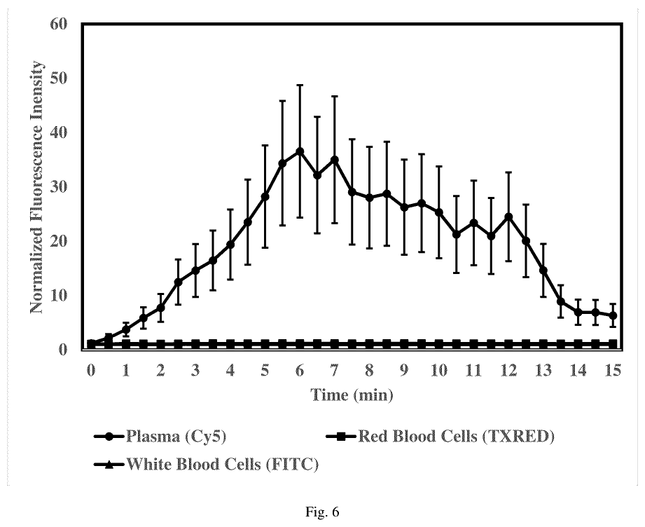

FIG. 6 shows the average relative fluorescence intensity of TXRED and FITC channels indicating the extraction of blood plasma without leakage and rupture of RBCs and WBCs inside the reaction chamber in different concentrations of spiked blood plasma.

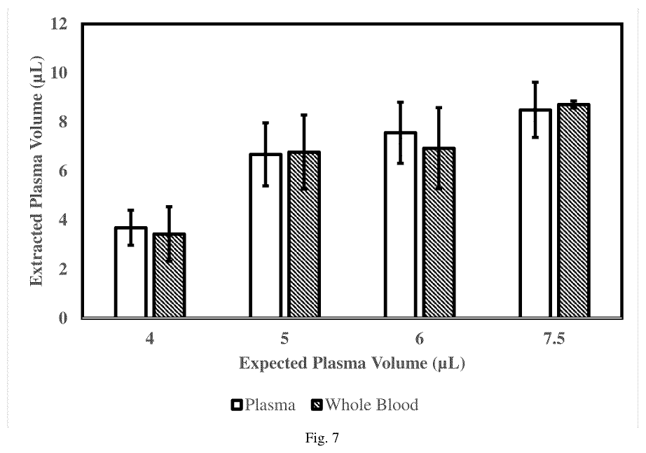

FIG. 7 is a graph comparing extracted plasma volumes between blood plasma and whole blood samples in different expected plasma volumes. Thus, it is believed that the microfluidic device herein provides efficient and virtually complete blood plasma separation from whole blood.

### EXAMPLE 1

### Whole Blood Component Labelling

A human blood sample is centrifuged to isolate red blood cells (RBCs) and white blood cells (WBCs). The isolated cells were then washed 3 times with 1× PBS buffer before being mixed with solution containing 100 μg/ml DiD (lipophilic dye carbocyanine 1,1′ dioctadecyl-3,3,3′,3′-tetramethylindodicarbocyanine, 4-chlorobenzenesulfonate salt solid (DiD; Lumiprobe, Hunt Valley, Maryland, USA) for RBCs and 1 μg/ml CellTracker™M Green (5-chloromethyl fluorescein diacetate (a.k.a., CMFDA, Lumiprobe, Hunt Valley, Maryland, USA) for WBCs with a 1:1 volume ratio and incubated for 30 minutes with continuous mixing in room temperature.

The stained blood cells are washed again 3 times with 1× PBS buffer and the separated plasma from the centrifugation step is reintroduced to the stained blood cells with the hematocrit (Hct) score of 50%. The RBCs stained with DiD are detected with the Texas Red/TXRED channel (see FIG. 3A) and the WBCs stained with CMFDA green are detected with the FITC green channel (see FIG. 3B).

To model the blood plasma extraction, the blood plasma was spiked with cyanine 5 amine (Cy5; Lumiprobe) fluorescence dye with different concentrations (0, 10, 20, 50, 100 μg/mL). The labelled whole blood sample is then seen under a bright field and fluorescence microscopy to ensure that all components are stained correctly.

### Blood Plasma Separation and Extraction

To determine the performance of the blood plasma separation and extraction, a time-lapse study is conducted by injecting 10 μL of the whole blood samples (Hct 50%) into the device followed by 20 μL of buffer through the manifold inlet. Images were taken for brightfield, Cy5 red, FITC green, and TXRED channels every 30 seconds for 20 minutes to monitor the flow of blood plasma that is being extracted by the sequential draining as well as the possibility of RBCs and WBCs leaking or rupturing during the filtration process. See FIG. 4. The time-lapse images were then processed in ImageJ (National Institute of Health (NIH), Bethesda, Maryland, USA) to attain the fluorescence image intensity in the reaction chamber. The intensity values are normalized by dividing the raw intensity value with the value of the background. The intensity of Cy5 determines the extracted volume of blood plasma in relation to time. The DiD and CMFDA green intensity are used together with the brightfield images to observe RBCs and WBCs leakage and rupture.

### Volume Calculation

To attain volume of extracted plasma by weight, densities of the whole blood sample, separated blood plasma, and manifold buffer are calculated by weighing a known volume using a balance. Afterwards, individual porous membranes used for capillary pumps are weighed before and after the extraction process. These values are subtracted from the weight value of the control when only the manifold buffer is inserted into the device. The subtracted weight values are then converted to volume using the densities of the respective fluids.

### Results

Without intending to be limited by theory, it is believed that when the device herein successfully achieves sequential draining. The device is tested with a whole blood sample and food dye to visualize the sequential draining. As expected, the whole blood from the sample inlet prioritizes first extracting the blood plasma through the separation membrane while the meniscus in the manifold inlet stays in place. Only when the blood plasma is completely drained (see FIG. 6 at the 6 min mark) does the manifold meniscus start to drain. In FIG. 6, at 15 minutes the process is finished as all of the fluid is emptied from the channel. Comparatively, we can also observe that no blood cells are leaking in the filtration process as seen from the brightfield images as well as images from the TXRED and FITC channels.

Through time-lapse study, it can be observed that the blood plasma extraction happens 1 minute after the manifold buffer injection and completed after 15 minutes indicated by the change of respective increase and decrease of the Cy5 fluorescence intensity in the reaction chamber. We also studied the comparison between the extraction of whole blood and pure plasma samples. Based on FIG. 5A and 5B, spiked plasma samples have a faster completion rate reaching the peak and decrease at a rapid pace. In contrast, the whole blood samples extraction has a lower peak and seems to be more of a plateau. This is due to the inclusion of blood cells being filtered in the separation membrane that acts as a resistance for the filtration.

Normalized fluorescence intensity of Cy5 for extracted plasma, TXRED and FITC channels indicates the leakage and rupture of RBCs and WBCs. The results show that along the extraction of blood plasma, the Cy5 channel is the only channel that shows an increase, while the other channels stay undetected (FIG. 6). With this we can confirm that this device can fully filter RBCs and WBCs without them rupturing during the extraction process.

Volume results through the weighted liquid before and after the reaction indicates that this process can extract 50% of the original volume of the whole blood sample of 8 μL, 10 μL, 12 μL, and 15 μL which correlates to the expected plasma volume of 4 μL, 5 μL, 6 μL, and 7.5 μL respectively. This value correlates with the hematocrit count done on the whole blood sample, indicating a full extraction of blood plasma from the whole blood sample (FIG. 7). Additionally, this value is also similar to volume extracted based on the use of bare plasma samples prepared with expected volumes of 4 μL, 5 μL, 6 μL, and 7.5 μL into the system for comparison, meaning that this plasma volume extracted is unaffected by the presence of blood cells.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

What is claimed is:

1. A microfluidic device comprising:
A. a blood sample inlet;
B. a separation membrane comprising:
i. a top layer proximal to the sample inlet, the top layer having an average pore size of from about 1 μm to about 50 μm in diameter; and
ii. a bottom layer distal from the sample inlet, the bottom layer having an average pore size of from about 0.05 μm to about 20 μm in diameter;
C. a manifold inlet in fluid connection with the blood sample inlet at a junction;
D. a capillary pump in fluid connection with and downstream of the junction; and
E. an air vent in fluid connection with the capillary pump,
wherein the separation membrane is positioned between the blood sample inlet and the junction.

2. The microfluidic device according to claim 1, wherein the top layer has an average pore size of from about 3 μm to about 20 μm in diameter and the bottom layer has an average pore size of from about 0.1 μm to about 7 μm in diameter.

3. The microfluidic device according to claim 1, wherein the separation membrane further comprises an additional layer, and wherein the additional layer is located proximal to the sample inlet and above the top layer.

4. The microfluidic device according to claim 3, wherein the additional layer has a pore size of from about 20 μm to about 100 μm in diameter.

5. The microfluidic device according to claim 1, further comprising a reaction chamber to detect the biomarkers in extracted plasma in fluid connection with the separation membrane, wherein the reaction chamber is downstream of the separation membrane.

6. The microfluidic device according to claim 5, wherein the biomarker is selected from the group consisting of alpha fetoprotein, a SARS COV-2 antibody, a SARS COV-2 antigen, serum albumin, prostate-specific antigen, blood creatinine, blood cystatin C, and a combination thereof.

7. The microfluidic device according to claim 5, wherein the reaction chamber comprises a capture mechanism selected from the group consisting of an immobilized antibody, an immobilized antigen, immobilized microparticles, and a combination thereof.

8. The microfluidic device according to claim 5, wherein the reaction chamber contains a reactant for a reaction selected from the group of a color reaction, an antibody reaction, an enzymatic reaction, an electrochemical reaction, fluorescence, chemiluminescence, and a combination thereof.

9. The microfluidic device according to claim 7, wherein the reaction chamber contains a reactant for a reaction selected from the group of a color reaction, an antibody reaction, an enzymatic reaction, an electrochemical reaction, fluorescence, chemiluminescence, and a combination thereof.

10. The microfluidic device according to claim 8, wherein the reaction chamber contains a reactant for a reaction selected from the group of a color reaction, an antibody reaction, an enzymatic reaction, an electrochemical reaction, fluorescence, chemiluminescence, and a combination thereof.

11. The microfluidic device according to claim 1, wherein the capillary pump is selected from the group consisting of a porous-material-based capillary pump, a single microchannel with a hydrophilic surface, a multiple microchannel with a hydrophilic surface, a chamber with a hydrophilic microstructure, and a combination thereof.

12. The microfluidic device according to claim 1, wherein the capillary pump comprises a filter.

13. The microfluidic device according to claim 12, wherein the filter comprises cellulose, cotton linter, and a combination thereof.

14. A method for separating blood plasma from a blood sample comprising the steps of:
A. providing the microfluidic device according to claim 1, wherein the air vent is either a closed air vent or opened air vent;
B. providing a blood sample comprising a plurality of red blood cells and blood plasma therein;
C. adding the blood sample to the blood sample inlet;
D. allowing the blood sample to flow from the blood sample inlet to the separation membrane;
E. filtering the red blood cells from the blood plasma;
F. adding a working fluid to the manifold inlet; and
G. extracting the blood plasma separated by the separation membrane via sequential draining.

15. The method for separating blood plasma from a blood sample according to claim 14, wherein the blood plasma flows from the separation membrane downstream to the capillary pump.
